(19) United States
(12) Patent Application Publication
(10) Pub. No.: US 2011/0183095 A1
(43) Pub. Date: Jul. 28, 2011

(54) REFRIGERANT ADDUCTION HOLLOW ELEMENT IN A VEHICLE

(76) Inventor: Roberto Defilippi, Torino (IT)

(21) Appl. No.: 12/994,573

(22) PCT Filed: May 26, 2009
(86) PCT No.: PCT/IB09/05713

§ 371 Date: Mar. 14, 2011

(30) Foreign Application Priority Data
May 27, 2008 (IT) TO2008A000404

(51) Int. Cl. B32B 1/08; B32B 27/34

(52) U.S. Cl. 428/36.4; 428/36.9

(57) ABSTRACT

A refrigerant adduction system in a vehicle comprising a hollow element comprising a layer of polyamide 6,10. Preferably, the hollow element is a pipe or a joint. Preferably the pipe comprises a layer of polyamide 6,10 and a layer of a polyamide material selected from PA12 and a copolyamide obtained from dicarboxylic units which are isophthalic acid or terephthalic acid by more than 60%. Preferably the joint comprises a polyamide 6,10 filled with fibres.

### TECHNICAL FIELD

The present invention relates in general to a hollow element for an air-conditioning system of a vehicle in which a refrigerant circulates.

### STATE OF THE PRIOR ART

Motor vehicle air conditioning systems are circuits through which refrigerant flows and are formed by a plurality of components, comprising in particular a compressor, a condenser, a drying tank, an expander system and an evaporator. All of these components are connected together by means of tubular elements which have at the ends thereof fastening elements and joint means which ensure watertightness.

The constitutive components of the air conditioning systems are housed within the engine compartment of the vehicle, with the compressor drawn by the drive shaft of the motor vehicle, while the other components are fixed to portions of the body. In the air conditioning system there are low pressure and high pressure elements. The latter may be subjected in use to pressures of the refrigerant on the order of 30 bars.

The refrigerant that has long been used for vehicles is a Freon gas known as “R-134”. To overcome the polluting properties of this gas, it is especially important that a pipe for the adduction of this gas is substantially impermeable thereto. Furthermore, a low permeability is also desirable so that the system maintains its functionality and efficiency in the course of time.

However, international environmental regulations impose that alternative solutions to Freon R-134 having a lower global warming potential (GWP) are sought. Among these, 1234 YS gas available from Honeywell and Dupont has proven effective. However, even by using a lower GWP gas as refrigerant, it is still of the utmost importance that the elements, i.e. pipes and joints for its adduction, have the lowest possible permeability thereto, together with satisfactory high pressure mechanical properties, in particular after a long wear and substantially for the whole life cycle of the motor vehicle.

In particular, car manufacturers impose that the pipes intended to be used for the adduction of the refrigerant in the air conditioning system overcome a plurality of experimental tests, for instance heat burst tests to verify the mechanical features thereof, cyclic pressure variation resistance tests, tests for the permeability to the fluid to be adducted and resistance tests to chemical agents.

Generally, in air conditioning systems in the car manufacturing field, such requirements are satisfied by using, for the adduction of refrigerant, aluminium pipes at which ends brazed flanges and intermediate rubber pipes with bell joints or snap-fits moulded on the rubber itself are provided, possibly using this metal in combination with multilayer rubber pipes.

However, the general tendency in the car manufacturing field is to replace, where possible, the metal or rubber pipes with equivalent structures made of plastic, so as to reduce manufacturing costs as well as the overall weight of the resulting air conditioning system and also have a corresponding benefit for the CO₂ emissions in the engine in virtue of the lower consumptions.

In the past, many attempts have been made to identify polymers having a low-enough degree of permeability to “R-134”, but the results were not totally satisfactory.

A pipe for an air-conditioning system is known from

European patent application EP1498672, which is made as a single layer of a plastic or thermoplastic material, and more in particular polyamide 6,6.

However, this pipe for an air-conditioning circuit made as a single layer of polyamide 6,6 does not totally pass all of the tests recommended by the standards in the car manufacturing field, especially as far as the properties of cyclic pressure variation resistance at high temperatures and of impermeability to the refrigerant after aging are concerned.

Furthermore, it has been noted that, at laser weldings and junctions, chippings and fractures often occur when the pipe is exposed to chemical agents (for instance during chloride resistance tests), especially in areas subjected to stress conditions due to the reduced resistance of these materials to the above cited chemical agents.

### OBJECT OF THE INVENTION

It is the object of the present invention to therefore provide elements, in particular pipes and joints made of thermoplastic material allowing to effectively replace the elements based on the use of aluminium, which are currently used in air-conditioning systems in the car manufacturing field, and to solve the problems associated to the use of known solutions made of plastic.

In particular, it is the object of the. present invention to provide plastic elements, i.e. pipes and joints, for the adduction of a refrigerant within the air-conditioning system of a vehicle, having a permeability to the refrigerant comparable to that of the aluminium pipes commonly used in the field and definitely lower than that of rubber pipes, and a resistance to high working pressures for a time substantially equivalent to the whole life cycle of the vehicle. Furthermore, it is the object of the invention to provide a pipe of thermoplastic material for an air-conditioning system which can resist chemical attacks.

According to the present invention a refrigerant adduction hollow element is made according to claim 1.

It is another object of the present invention to provide a refrigerant adduction system in a vehicle according to claim 21.

### BRIEF DESCRIPTION OF THE DRAWINGS

For a better understanding of the present invention, it will further be described with reference to the accompanying figure/s, which shows/show:

FIG. 1 is a diagrammatic representation of an air-conditioning system of a vehicle;

FIG. 2a is a perspective view of a refrigerant adduction pipe;

FIG. 2b shows a right sectional view of the pipe according to the invention.

### BEST MODE FOR CARRYING OUT THE INVENTION

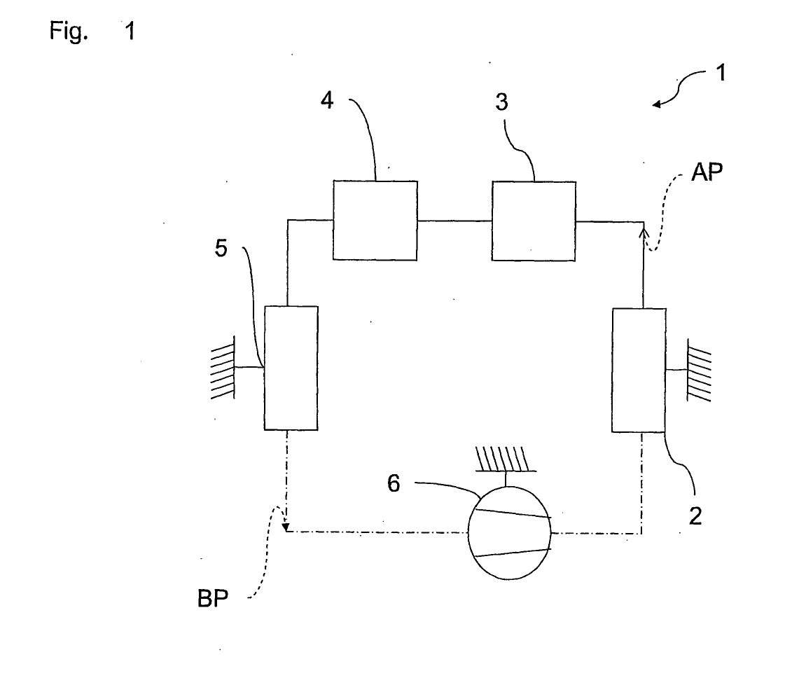

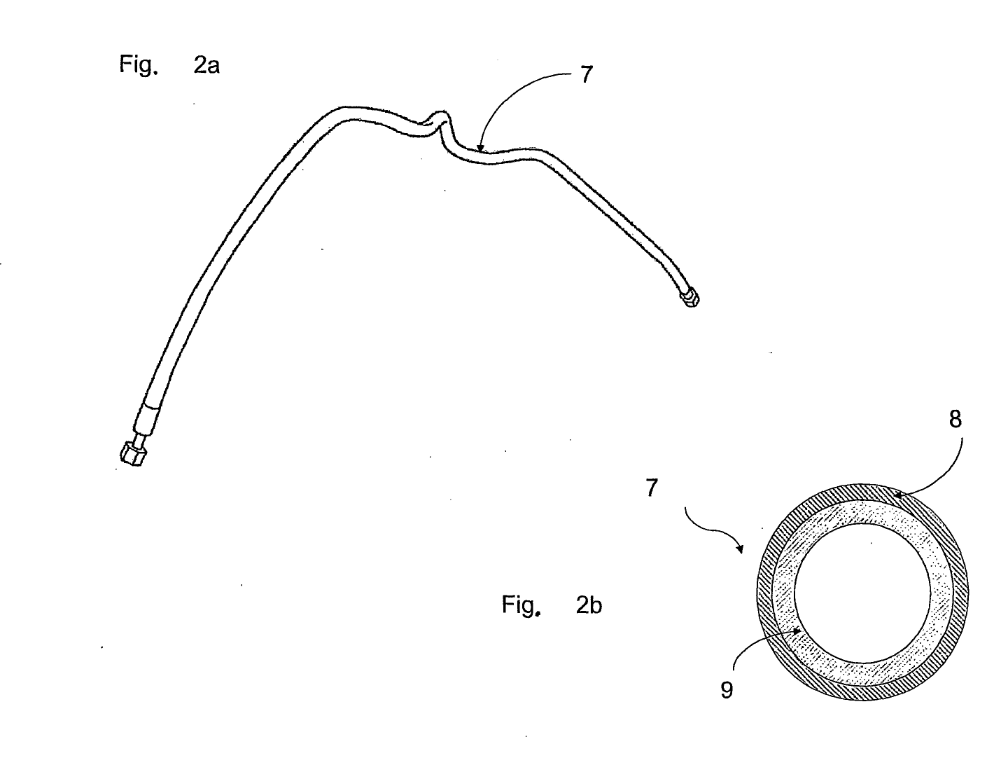

In FIG. 1 numeral 1 indicates as a whole an air conditioning system for a motor vehicle, comprising a condenser 2, a drying tank 3, an expander system 4, an evaporator 5, a compressor 6. A low pressure section BP is identified in FIG. 1, by a slash-dot line. A solid line instead indicates a high pressure section AP, substantially identifiable between compressor 6 and expander system 4. In the high pressure section AP the refrigerant (R-134) is used at temperatures around 100° C. and at a pressure on the order of 20 bars. The components of the air-conditioning system shown in FIG. 1 are connected together by a plurality of hollow components 7 (pipe segments or joint elements) an example of which is shown in FIG. 2a.

According to the present invention, a hollow component 7 of air-conditioning system 1 comprises at least one first layer 8 comprising a thermoplastic copolymer comprising a polyamide 6,10.

Alternatively, tube 2 is made of a single layer comprising a thermoplastic copolymer comprising a polyamide 6,10.

Preferably, the layer comprising polyamide 6,10 comprises more than 60% polyamide 6,10. More preferably, the layer comprises more than 90% polyamide 6,10. Even more preferably, the layer is totally formed by polyamide 6,10.

Preferably, polyamide 6,10 comprises more than 60% of a copolymer obtained from a first monomer comprising units of sebacic acid and a second monomer comprising units of hexamethylenediamine. More preferably, polyamide 6,10 comprises more than 90% of a copolymer obtained from a first monomer comprising units of sebacic acid and a second monomer comprising units of hexamethylenediamine. Even more preferably, polyamide 6,10 consists of a copolymer obtained from a first monomer comprising units of sebacic acid and a second monomer comprising units of hexamethylenediamine.

Preferably, for at least one layer of polyamide 6,10, a resin of the Grilamid® S series produced by EMS is used. For instance, the Grilamid® S FR5347 resin may be used.

This resin, having a density of about 1.07 g/cm³, has a melting point equivalent to about 220° C. and a

Young's module of about 2.3 GPa. As well as marked properties of chemical resistance to oils, for instance PAG2 or POE, to combustibles, to. water and to saline solutions, a pipe made of this resin also has good properties of short-term thermal resistance and resistance to hydrolysis, reduced tendency to absorb water, and a better mechanical stability and resistance to abrasion, with respect to pipes made of other polyamides such as PA6 and PA12. Furthermore, as one of its constitutive monomeric units is mainly sebacic acid, a compound naturally available in great amounts as it may be.obtained from castor oil, its use advantageously consists in a form of use of renewable resources.

According to an embodiment, the component or pipe 7 according to the invention formed by a single layer 8 comprising polyamide 6,10 preferably has a thickness in the range between 1.5 and 3 mm.

According to an alternative embodiment of the invention, component 7 further comprises a second layer 9 comprising a polyamide resin preferably selected from polyamide 12 and a copolyamide obtained from dicarboxylic units which are terephthalic acid or isophthalic acid by more than 60%. Preferably, the second layer comprises at least 60% of said polyamide resin. Preferably, the second layer comprises at least 90% of said polyamide resin. Even more preferably, second layer 9 is entirely made of said polyamide resin.

According to an embodiment of the invention, said polyamide resin is a polyamide 12 modified to resist cold impacts.

Preferably, polyamide 12 is selected so as to have a melting temperature in the range between 170 and 176° C., a tensile strength in the range between 25 and 35 MPa, a bending strength in the range between 20 and 30 MPa, a bending modulus in the range between 400 and 600 MPa, an impact strength in the range between 100 and 120 kJ/m² at 23° C. and between 10 and 20 kJ/m² at —40° C.

Preferably, component 7 comprises a first layer 8 comprising polyamide 6,10 and a second layer 9 comprising polyamide 12, first layer 8 being internal to second layer 9.

According to a further embodiment of the invention, this copolyamide is a polyphtalamide (PPA).

Preferably, this copolyamide is a copolymer obtained from dicarboxylic units which are terephthalic acid by more than 60% and diamine units which are 1,9-nonandiamine or 2-methyl-1,8-ottandiamine by more than 60%.

More preferably, the dicarboxylic units are terephthalic acid by more than 90%. Even more preferably, terephthalic acid forms 100% of the dicarboxylic units.

Preferably, the diamine units are 1,9-nonandiamine or 2-methyl-1,8-ottandiamine by more than 60%. More preferably, the diamine units are 1,9-nonandiamine or 2-methyl-1,8-ottandiamine by more than 90%. Even more preferably, 1,9-nonandiamine or 2-methyl-1,8-ottandiamine form 100% of the diamine units.

Examples of dicarboxylic units other than terephthalic acid comprise aliphatic dicarboxylic acids such as malonic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid and suberic acid; alicyclic dicarboxylic acids such as 1,3-cyclopentandicarboxylic acid and 1,4-cycloesandicarboxylic acid; aromatic dicarboxylic acids such as isophthalic acid, 2,6-naphthalendicarboxylic acid, 2,7-naphthalendicarboxylic acid, 1,3-phenylendioxydiacetic acid, diphenic acid, 4,4′-oxydibenzoic acid, diphenylmethane-4,4′-dicarboxylic acid, diphenylsulphone-4,4′-dicarboxylic acid and 4,4′-biphenyldicarboxylic acid; or a mixture thereof

Among these, aromatic dicarboxylic acids are preferred.

Examples of diamine units other than the above mentioned 1,9-nonandiamine and 2-methyl-1,8-ottandiamine comprise aliphatic diamines such as ethylenediamine, propylenediamine, 1,4-butandiamine, 1,6-hexanediamine, 1,8-octanediamine, 1,10-decandiamine, 3-methyl-1,5-pentanediamine; alicyclic diamines such as cyclohexanediamine, methyl cyclohexanediamine and isophorondiamine; aromatic diamines such as p-phenylenediamine, m-phenylenediamine, p-xylenediamine, m-xylendiamine, 4,4′-diaminodiphenylmethane, 4,4′-diaminodiphenylsulphone, 4,4′-diaminodiphenyl ether; and an arbitrary mixture thereof.

Such a polyamide is preferably P9T of the type disclosed in U.S. Pat. No. 6,989,198. More preferably, the polyamide resin is a Genestar® resin developed by Kuraray. Even more preferably it is a Genestar® resin developed by Kuraray, such as Genestar 1001 U03, U83, or H31.

The junctions between the various pipe segments which, connected together, form the refrigerant adduction lines in refrigerant adduction system 1 on a vehicle are made by means of joints also formed by hollow components, so as to allow refrigerant to flow through, and are appropriately shaped so as to allow a solid and fast fit of the pipe segments.

According to the invention the hollow components which form joints also comprise a layer comprising the previously disclosed polyamide 6,10.

Preferably, these hollow components further contain fibres and more preferably glass fibres.

Preferably the glass fibres are added in an amount in weight between 10 and 60% with respect to the polyamide. Optimal results in the tests have been obtained with a weight percentage in the range between 20 and 40%, for instance 30%.

According to a preferred embodiment of the invention, the glass fibres have a length in the range between 0.05 and 1.0 mm, but even more preferably have a length in the range between 0.1 and 0.5 mm.

Furthermore, these fibres preferably have a diameter in the range between 5 and 20 μm, and more preferably have a diameter in the range between 6 and 14 μm.

Preferably, the hollow elements that form joints 3 comprise at least 60% of such polyamide 6,10 filled with glass fibres. More preferably, joints 3 comprise at least 90% of such polyamide 6,10 filled with glass fibres. Even more preferably, they are totally made of such polyamide 6,10 filled with glass fibres. Preferably, for joints 3, a polyamide resin of the

Grilamid® S series produced by EMS filled with glass fibres is used. For example, the Grilamid® S FR5351 resin may be used as it allows in virtue of its chemical compatibility with the material of which the tube of the invention is made to obtain the junction by laser welding, as an alternative to cold mounting solutions.

The pipes according to the invention meet the requirements imposed by car manufacturers for the use in air-conditioning systems. In particular, the layer made of PA 6,10 can meet the requirements of permeability and resistance to pressure oscillations, even after aging. Furthermore, the coupling of the layer made of PA 6,10 with an outer layer made of PA12, PPA or P9T allows to overcome the problems connected to the resistance to chemical attack avoiding chipping and breaking at weldings or to the limited resistance of the threading.

### EXAMPLE 1

A single layer pipe of Grilamid S FE 5347 7×11 and therefore with a wall thickness of 2 mm has been subjected to a series of lab tests and its performance and properties have been compared with those of tubes made according to different structures known in the art.

Heat Burst Tests

The tests have been carried out at a temperature of 120° C., after stabilisation for 1 h at the test temperature. An increasing hydraulic pressure has been applied on the previously disclosed pipe, with an increase of 5 bar/s (or 1.66 bar/s) until the pipe bursts. The pressure at which the burst occurs is therefore compared with the values recommended for use for instance by a car manufacturer.

A pressure between 75 and 85 bars, which is significantly more than the recommended 30 bars, has been recorded for the pipe according to the invention. The test was also repeated after pulsed pressure tests (disclosed in the following), resulting in a value of 67-68 bars, still significantly over the recommended 30 bars, being recorded.

Permeability Tests

These tests have the aim of measuring the amount of fluid that flows out through the wall of the pipes by means of the weight loss. In order to obtain a statistically significant result, the tests are carried out on 4 pipes at the same time.

The lengths (L₁, L₂ . . . L₄) of the tested tubes, except for the joints, are first of all measured at an atmospheric pressure. Two closing devices, one of which is provided with a filling valve, are mounted on the ends of the pipes.

The inner theoretical volume of the first 3 pipes is computed and an amount of HFC134 of 0.55 g/cm³ which is equivalent to about 50% of the inner volume of the tested pipe is introduced therein. A halogen detector is used to verify that there are no leakages from the closing devices. The 4 pipes (3 full ones and a blank sample) are introduced in an environmental chamber at a temperature of 100° C. for 1h, and the test is repeated verifying with the halogen detector. At this point, the 4 pipes are conditioned in the environmental chamber at a 100° C. for 24h.

When this step of conditioning is completed, the pipes are weighted and the values P₁, P₂, . . . P₄ are recorded.

Then, the pipes are again conditioned at 100° C. for 72h, after which they are weighted and the single weight losses ΔPᵢ are determined. The weight loss of the pipes charged with refrigerant is therefore assessed as the average value on the three pipes, and the value detected for the “blank” pipe is subtracted thereto. The resulting difference is the permeability index in g/m²/72h.

A value in the range between 1.82 and 2.73 g/m^{b /72}h has been recorded for the pipe according to the invention.

Pulsed Pressure Resistance Tests

The tested pipes are mounted on a test bench provided with a device allowing to send pressure pulses. The pipes, mounted like a U with a radius of curvature equivalent to the minimum provided for the tested pipe, are internally filled with the lubricant provided for the compressor or with a silicone oil; the environment, in which the test is performed, contains air. Inner fluid and air are taken to a temperature of 100-120° C. and subjected to cycles with test pressure equivalent to 0±3.5 MPa (or between 0 and 1 MPa, depending on the kind of pipe), with a test frequency of 15 cycles a minute. At least 150,000 cycles are carried out, which are to be continued up to fracture when the same has not occurred within 150,000 cycles.

A verification cycle is performed at the end, by removing the pipe from the test bench, dipping it in water, and sending a pneumatic pressure of 3.5 MPa for 30 s checking that there are no leakages. In case bubbles are formed, the pressure is maintained for 5 minutes, in order to verify that it is really a leakage and not, for example, air which is trapped between the layers of the pipe (in case of a multilayer pipe).

When the analysis is completed, pipe samples are sectioned at the end joint areas and visually examined to verify there are no tears on the inner duct. The occurrence of this kind of defect would be a reason to fail the test.

No fractures have occurred for the pipe according to the invention after 150,000 cycles.

Zinc Chloride Resistance Tests

The test is performed on three linear lengths of pipe having a length 300 mm and 3 lengths provided with ends. The linear lengths are folded in a U with a radius equivalent to about 5 times the outer diameter of the tested tube, crossing the free ends. These, and the lengths provided with ends, are dipped in a 50% in weight aqueous solution of ZnCl₂ at a temperature of 23° C. for 200 h. The level of solution must not involve the free ends of the pipe (for 20-30 mm), which will have to be closed by appropriate caps in any case.

At the end of the test, after extraction from the solution, the condition in particular of the curved area and of the end area is checked, comparing the result with what has been recommended by car manufacturers.

Calcium Chloride Resistance Tests

The pipe lengths are prepared similarly to the zinc chloride resistance test. They are then dipped in a 50% in weight aqueous solution at a temperature of 50° C. for 200 h. A reflux circuit for cooling vapours is placed over the thermostated bath. At the end of the test, the condition in particular of the curved area and of the end area is checked, comparing the result with what has been recommended by car manufacturers.

Only pipes according to the invention pass all the tests required to ensure a long-enough life of the pipe according to the needs of car manufacturers.

1. A refrigerant adduction hollow element (1) in a vehicle comprising at least one layer of polyamide 6,10.

2. The hollow element according to claim 1, characterised by consisting of said layer of polyamide 6,10.

3. The hollow element according to claim 1 or 2, characterised in that said polyamide 6,10 is obtained from a first monomer comprising units of sebacic acid and a second monomer comprising units of hexamethylendiamine.

4. The hollow element according to claim 1 or 3, characterised by comprising a second layer comprising a polyamide resin.

5. The hollow element according to claim 4, characterised in that said polyamide resin is selected from polyamide 12 and a copolyamide obtained from dicarboxylic units which are terephthalic acid or isophthalic acid by more than 60%.

6. The hollow element according to claim 5, characterised in that said second layer comprises more than 60% of said polyamide resin.

7. The hollow element according to claim 9, characterised in that said second layer entirely consists of said polyamide resin.

8. The hollow element according to any of claims 5 to 7, characterised in that said polyamide 12 is an impact modified polyamide.

9. The hollow element according to claim 8, characterised in that said polyamide 12 has a melting temperature in the range between 170 and 180° C., a tensile strength in the range between 25 and 35 MPa, a bending strength in the range between 20 and 30 MPa, a bending modulus in the range between 400 and 600 MPa, an impact strength in the range between 100 and 120 kJ/m² at 23° C. and between 10 and 20 kJ/m² at −40° C.

10. The hollow element according to any of claims 5 to 7, characterised in that said polyamide resin is polyphtalamide (PPA).

11. The hollow element according to any of claims 5 to 7, characterised in that said polyamide resin is a copolymer P9T obtained from dicarboxylic units which are terephthalic acid by more than 60% and diamine units which are 1,9-nonandiamine or 2-methyl-1,8-ottandiamine by more than 60%.

12. The hollow element according to claim 11, characterised in that said copolymer is filled with elastomers in a percentage in weight in the range between 10 and 40%.

13. The hollow element according to any of the preceding claims, characterised in that said first layer has a thickness in the range between 1.5 mm and 3 mm.

14. The hollow element according to any of claims 8 to 18, characterised in that said second layer has a thickness in the range between 0.1 mm and 0.5 mm.

15. The hollow element according to any of the preceding claims, characterised by being a pipe.

16. The hollow element according to any of claims 1 to 15, characterised by being a joint.

17. The hollow element according to claim 16, characterised by comprising fibres.

18. The hollow element according to claim 17, characterised in that said fibres are glass fibres.

19. The hollow element according to claim 18, characterised in that said glass fibres have a length in the range between 0.05 and 1.0 mm.

20. The hollow element according to claim 17, characterised in that said glass fibres have a diameter in the range between 5 and 20 μm.

21. A refrigerant adduction system in a vehicle characterised by comprising a hollow element according to any of claims 1 to 20.
